(19) United States
(12) Patent Application Publication
(10) Pub. No.: US 2026/0050921 A1
(43) Pub. Date: Feb. 19, 2026

(54) EFFICIENT AND SECURE VALUE TRANSFER METHOD AND SYSTEM

(71) Applicant: Visa International Service Association, San Francisco, CA (US)

(72) Inventors: Christopher Young Bin Kim, Glen Rock, NY (US); Benjamin Aquilino, Forestville, CA (US); Erin Samantha Gray, New York, NY (US); Dennis Dorfmeister, Osterhofen (DE)

(73) Assignee: Visa International Service Association, San Francisco, CA (US)

(21) Appl. No.: 19/300,469

(22) Filed: Aug. 14, 2025

Related U.S. Application Data
(60) Provisional application No. 63/683,439, filed on Aug. 15, 2024.

(51) Int. Cl. G06Q 20/40

(52) U.S. Cl. CPC G06Q 20/401

(57) ABSTRACT

A method is disclosed. The method includes a) receiving, from a resource provider computer, a request to create a mandate, b) communicating with a user device, c) creating the mandate, and d) providing, to the resource provider computer, a mandate identifier for the mandate. The method also includes e) receiving a call from the resource provider computer with the mandate identifier to initiate a transfer associated with the mandate, f) initiating the transfer associated with the mandate by initiating transfer processing, g) providing to the user device, information regarding the transfer processing, and h) notifying the user device that the transfer processing for the transfer has been authorized. Steps b)-g) are performed while the user device is in communication with the processing computer without the resource provider computer as an intermediary between the user device and the processing computer.

### CROSS-REFERENCES TO RELATED APPLICATIONS

This application is a non-provisional application which claims the benefit of the filing date of U.S. Provisional Application No. 63/683,439, filed on Aug. 15, 2024, which is herein incorporated by reference in its entirety for all purposes.

### BACKGROUND

Value transfers to send values to resource providers involve extensive and complicated processing steps. Because of this, some resource providers (e.g., merchants, data access providers, etc.) use backend processing systems provided by third parties to process their value transfers.

After a transfer from a sender record (e.g., a sender account) to a receiver record (e.g., a receiver account) is initiated, processing errors can sometimes occur. An example of a processing error can include a sending entity computer being unresponsive to a request for information. In this case, the third party backend processing system would notify the resource provider, who would in turn notify the sender user seeking to conduct the transfer transaction.

In such conventional systems, the resource provider needs to adapt their system to process any error or status messages (e.g., a reason why processing is slow) related to the value transfer processing performed by a backend processing system in order to provide them to the sender user. In addition, the resource provider needs to continually update their system to accommodate changes that the third party backend processing system might make. This can be difficult and time consuming as it requires constant coordination between the third party backend system and the resource provider system.

Another problem with conventional value transfers relates to the transfer of sensitive information. When conducting value transfers, the resource provider can receive sensitive information such as account numbers from users. It would be desirable to limit the exposure of such sensitive to resource providers to reduce the chance the sensitive information could be stolen through hacking and man-in-the-middle attacks.

Embodiments of the invention address these and other problems, individually and collectively.

### SUMMARY

One embodiment includes a method comprising: a) receiving, by a processing computer from a resource provider computer, a request to create a mandate; b) initiating, by the processing computer, communicating, by the processing computer, with a user device; c) creating, by the processing computer, the mandate; d) providing, by the processing computer to the resource provider computer, a mandate identifier for the mandate; e) receiving, by the processing computer, a call from the resource provider computer with the mandate identifier to initiate a transfer associated with the mandate; f) initiating, by the processing computer, the transfer associated with the mandate by initiating transfer processing; providing, by the processing computer, to the user device, information regarding the transfer processing; and h) notifying, by the processing computer, the user device that the transfer processing for the transfer has been authorized. Steps b)-g) are performed while the user device is in communication with the processing computer without the resource provider computer as an intermediary between the user device and the processing computer.

Another embodiment of the invention includes a processing computer comprising: a processor; and a non-transitory computer readable medium, the non-transitory computer readable medium comprising code, executable by the processor, for performing a method comprising: a) receiving, from a resource provider computer, a request to create a mandate; b) communicating with a user device; c) creating the mandate; d) providing, to the resource provider computer, a mandate identifier for the mandate; e) receiving a call from the resource provider computer with the mandate identifier to initiate a transfer associated with the mandate; f) initiating the transfer associated with the mandate by initiating transfer processing; g) providing to the user device, information regarding the transfer processing; and h) notifying the user device that the transfer processing for the transfer has been authorized, wherein steps b)-g) are performed while the user device is in communication with the processing computer without the resource provider computer as an intermediary between the user device and the processing computer

Another embodiment of the invention includes a method comprising: transmitting, by a user device to a resource provider computer over a communications network, a transfer request message; receiving, by the user device, from the resource provider computer, a redirect from the resource provider computer to a processing computer; providing, by the user device to the processing computer, a selection of a record identifier for a record at a sending entity computer, wherein the processing computer is programmed to create a mandate, provide to the resource provider computer a mandate identifier for the mandate, receive a call from the resource provider computer with the mandate identifier to initiate a transfer associated with the mandate, and initiate the transfer associated with the mandate by initiating transfer processing; and receiving, by the user device from the processing computer, a notification message that the transfer processing for the transfer has been authorized.

Another embodiment of the invention includes a user device comprising a processor; and a computer readable medium. The computer readable medium comprise code, executable by the processor, to perform a method. The method comprises transmitting, to a resource provider computer over a communications network, a transfer request message; receiving, from the resource provider computer, a redirect from the resource provider computer to a processing computer; providing, by the user device to the processing computer, a selection of a record identifier for a record at a sending entity computer, wherein the processing computer is programmed to create a mandate, provide to the resource provider computer a mandate identifier for the mandate, receive a call from the resource provider computer with the mandate identifier to initiate a transfer associated with the mandate, and initiate the transfer associated with the mandate by initiating transfer processing; and receiving, from the processing computer, a notification message that the transfer processing for the transfer has been authorized.

These and other embodiments are described in further detail below.

### BRIEF DESCRIPTION OF THE DRAWINGS

FIG. 1 shows a system and an overlaid flow diagram according to some embodiments of the invention.

FIGS. 2A-2D show some user interfaces and process steps.

FIG. 3 shows a block diagram of a first processing computer.

FIG. 4 is a block diagram of a user device according to an embodiment.

### DESCRIPTION

Prior to discussing embodiments of the invention, some descriptions of some terms may be useful.

“Account information” may include any suitable information associated with an account (e.g., a personal account number and/or payment device associated with the account). Such information may be related to the account or may be derived from information related to the account. Examples of account information may include a PAN (primary account number or “account number”), username, expiration date, and verification values such as CVV, dCVV, CVV2, dCVV2, and CVC3 values.

A “user” may include an individual. In some embodiments, a user may be associated with one or more personal accounts and/or mobile devices. The user may also be referred to as a cardholder, account holder, or consumer in some embodiments. A user may be a “receiver” that can receive something. A user can also be a “sender,” which is someone that can send something.

A “receiving entity” can be an entity that receives something, typically on behalf of a receiver. The receiving entity can manage a record (e.g., an account) of a receiver. Examples of receiving entities can include issuers, acquirers, service providers etc. A receiving entity can operate a receiving entity computer.

A “sending entity” can be an entity that sends something, typically on behalf of a sender. The sending entity can manage a record (e.g., an account) of a sender. Examples of sending entities can include issuers, acquirers, service providers etc. A sending entity can operate a sending entity computer.

An “issuer” may typically refer to a business entity (e.g., a bank) that maintains an account for a user. An issuer may also issue payment credentials stored on a user device, such as a cellular telephone, smart card, tablet, or laptop to the consumer.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

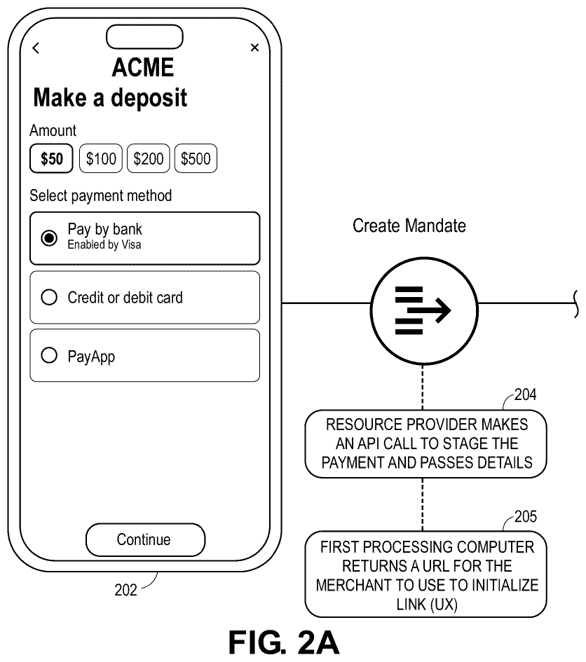

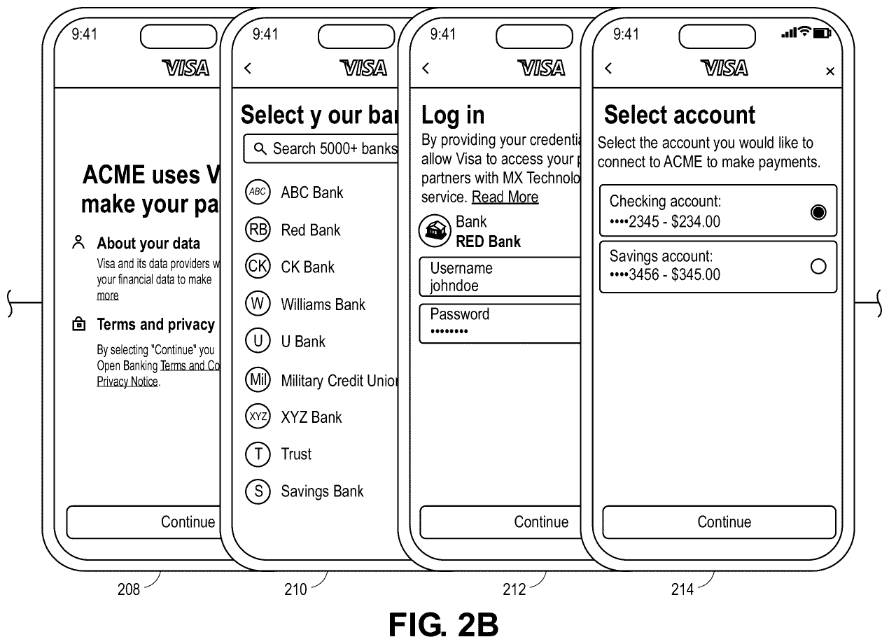

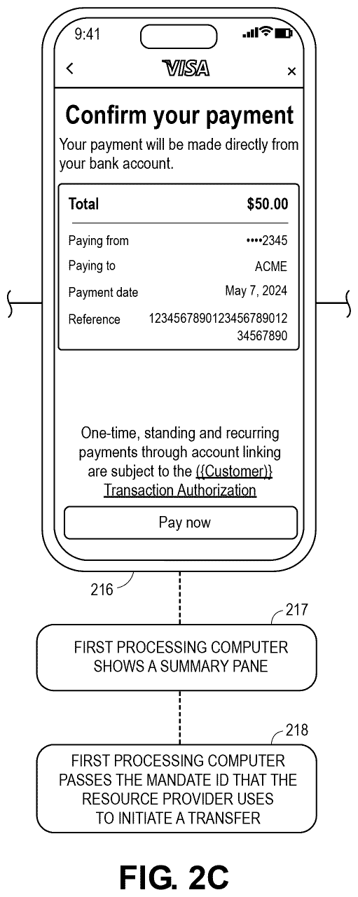

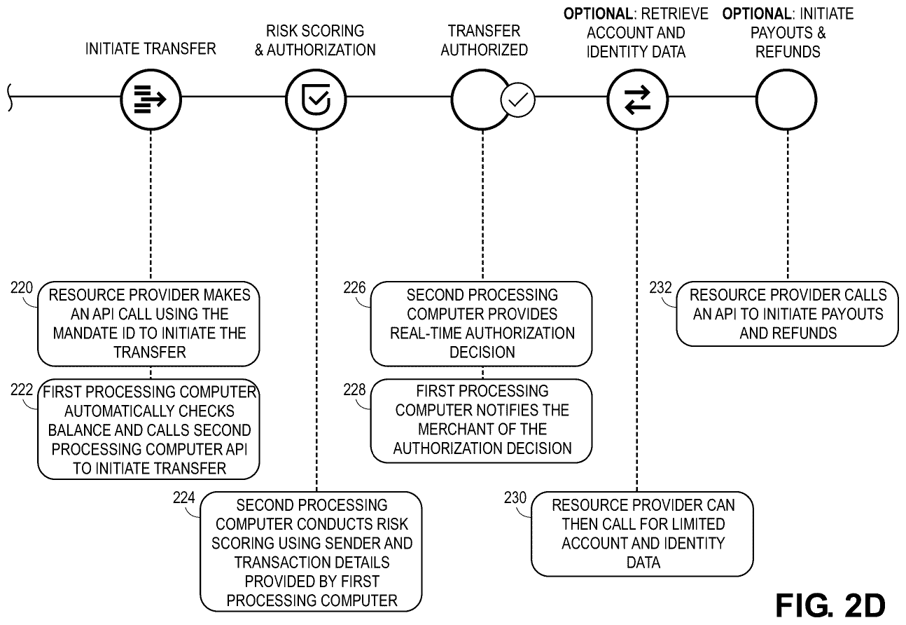

A “transfer application” can include an application facilitating the transfer of funds between multiple parties. For instance, a transfer application can include a peer-to-peer transaction application. The transfer application can be executed on a mobile device associated with a user, and the transfer application can be implemented using a server (e.g., an application server) in communication with the mobile device. The transfer application can provide an account (e.g., from a digital wallet which may be part of the transfer application or external to it) for each user. The transfer application can allow a user to select a recipient user to transfer a specified amount of funds to the recipient user. The transfer application can then transfer the specified amount from an account for the user to an account for the recipient user. In come embodiments, a transfer application may be resource provider application such as a gaming application that allows a user to provide wagers with respect to certain events (e.g., sporting events). The transfer application can show the user interfaces shown in FIG. 2A-2C, which are described below.

An “application server” can be a server computer that is specifically designed to run applications. For instance, an application server can perform processing tasks relating to the above-described transfer application, such as providing user account details to be displayed on the transfer application executing on the mobile device or facilitating the transfer of funds between users on the transfer application.

A “transaction” may be any interaction or exchange between two or more parties. For example, a transaction may include a first entity requesting resources from a second entity. In this example, the transaction is completed when the resources are either provided to the first entity or the transaction is declined.

A “transaction processing network,” or “processing network,” may refer to an electronic payment system used to accept, transmit, or process transactions made by payment devices for money, goods, or services. The processing network may transfer information and funds among authorization entities (e.g., issuers), acquirers, merchants, and payment device users.

A “mandate” can be a person's authorization to a bank or payment service provider to debit their account for a specific amount on a recurring or one-time basis. In some embodiments, a mandate may include information including a value to transfer (e.g., an amount of a payment), an obscured sender account identifier, a resource provider identifier, a date of the interaction, and a reference identifier.

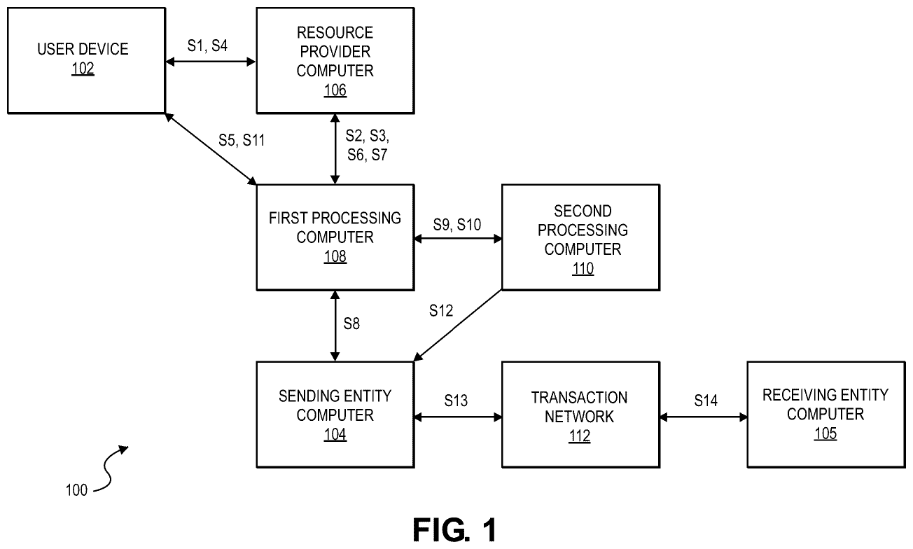

FIG. 1 shows a system 100 and an overlaid method for processing transactions according to some embodiments of the disclosure.

FIGS. 2A-2D show a user interface flow and processing steps for processing transactions according to some embodiments of the disclosure. FIGS. 2A-2D are described below with the description of FIG. 1.

The system 100 includes a user device 102 (e.g., a smartphone) operated by a user. The user device 102 can be in communication with a resource provider computer 106 and a first processing computer 108. The first processing computer 108 can be in communication with a second processing computer 110 and a sending entity computer 104. The second processing computer 110 can also be in communication with the sending entity computer 104. The sending entity computer 104 can be in communication with a receiving entity computer 105 via a transaction network 112.

The resource provider computer 106 can be operated by a resource provider such as a merchant, a data access provider, or a secure location access provider. If the resource provider is a merchant, then the resource provider computer 106 can be a merchant computer. In some embodiments, the resource provider computer 106 can be an application server for an application residing on the user device 102. The application could be a gaming application. The gaming application can allow the user of the user device 102 to place wagers on certain events (e.g., sporting events). In this case, the resource requested by the user may be money that may result from the a wager.

In some embodiments, the first processing computer 108 can be programmed to provide front end services (e.g., user interface) and resource provider facing components (e.g., payment APIs). The second processing computer 110 can be programmed to provide back end capabilities such as risk scoring, settlement, and collection services. In other embodiments, the first processing computer 108 and the second processing computer 110 can be in the part of the same system and can constitute a single processing computer.

The sending entity computer 104 can be a sending institution computer. In this case, a sending entity that operates the sending institution computer can be a sending bank that holds an account of the user operating the user device 102. In this case, the user of the user device 102 can be a sender user. The receiving entity computer 105 can be a receiving institution computer and the receiving entity can be a receiving bank. The receiving bank can hold an account of another user, which can be a receiver user.

The transaction network 112 can process transactions conducted between sending entity computers and receiving entity computers. In some embodiments, the transaction network can be a credit and debit card processing network, a wire transfer network, an ACH (automated clearing house) network, etc.

ACH is an electronic fund transfer through an ACH network including the Federal Reserve Bank from one account to another account, such as to a checking or savings account. ACH is typically used to process payments for settlement within one or two business days. ACH transactions are settled in a manner similar to the way checks are settled: The clearinghouse takes all ACH files received daily from its member banks, sorts them by the originating bank (the bank where the check was cashed or deposited) and the paying bank (the bank against which the check was drawn), totals the accounts, and credits or debits appropriate accounts accordingly. A company can issue an ACH debit for a purchase amount through the ACH network to a customer's account at the customer's bank. A company can also initiate a purchase upon receipt of an ACH credit.

One embodiment of the invention includes a method. The method includes a) receiving, from the resource provider computer 106, a request to create a mandate, b) communicating with the user device 102, c) creating the mandate, and d) providing, to the resource provider computer 106, a mandate identifier for the mandate. The method also includes e) receiving a call from the resource provider computer 106 with the mandate identifier to initiate a transfer associated with the mandate, f) initiating the transfer associated with the mandate by initiating transfer processing, g) providing to the user device, information regarding the transfer processing, and h) notifying the user device 102 that the transfer processing for the transfer has been authorized. Steps b)-g) are performed while the user device 102 is in communication with a processing computer (e.g., first processing computer 108) without the resource provider computer 106 as an intermediary between the user device 102 and the processing computer.

Prior to step S1, the user operating the user device 102 may interact with the resource provider computer 106 to attempt to obtain a resource. In some cases, the resource can be a good, service, secure data, a secure location, or money. In some embodiments, the resource provider computer 106 may include a gaming application server computer, which may provide support for a gaming application on the user device 102. If the user device 102 has a gaming application, the user can place wagers on events such as sporting events using the game application.

After the user of the user device 102 interacts with the user device 102 to select the resource desired, the user may be presented with options to provide access data to obtain the desired resource. The user may select a particular type of access data.

At step S1, the user device 102 transmits a request to the resource provider computer 106 to initiate communication with the first processing computer 108. For example, the user selects a first processing network interaction method (e.g., third party provider) in a checkout flow on the user device 102. In FIG. 2A, 202 illustrates an exemplary user interface prompting the user to select an interaction method. The user can select a payment amount and method, and can select “continue.” The user device 102 may transmit the selection to the resource provider computer 106.

Referring back to FIG. 1, at step S2, after receiving the selection from the user device 102, the resource provider computer 106 transmits a mandate creation request to the first processing computer 108. The resource provider computer 106 can make an API request to the first processing computer 108 comprising the details for the transaction, such as user details and payment amount (see 204 in FIG. 2A).

At steps S3-S4, after receiving the API request for the mandate from the resource provider computer 106, the first processing computer 108 initiates communication with the user device 102. In some embodiments, the first processing computer 108 sends a link (e.g., URL, URI) to the resource provider computer 106 (see step 205 of FIG. 2A). After receiving the link to the resource provider computer 106 provides the link to the user device 102. The selection of the link by the sender user initiates communication between the user device 102 and the first processing computer 108. In other embodiments, instead of a link, an iFrame can be used to allow communication between the user device 102 and the first processing computer 108.

When the user device 102 receives the link, a user interface flow for establishing a mandate is launched on the user device 102. User interfaces 208-216 in FIGS. 2B and 2C show an exemplary user interface flow for establishing a mandate. The user can consent to sharing data in user interface 208, select the sending entity that manages their account (e.g., bank) in user interface 210, and authenticate and select an account in user interfaces 212 and 214. The user confirms the mandate in user interface 216. The mandate may include information including a value to transfer, an obscured sender account identifier, a resource provider identifier, a data of the interaction, and a reference identifier. In step 217, the user is shown a summary of the mandate details.

Referring back to FIG. 1, at steps S5-S6, the first processing computer 108 receives confirmation from the user device 102 and generates and transmits a mandate identifier to the resource provider computer 106 (see step 218 of FIG. 2C).

At step S7, at the time of payment, the resource provider computer 106 initiates the value transfer (e.g., a payment transaction) by making an API call to the first processing computer 108 (see step 220 of FIG. 2D). The API call comprises the mandate identifier.

At steps S8-S9, after receiving the after receiving the mandate identifier from the resource provider computer 106, the first processing computer 108 initiates the value transfer. The first processing computer 108 initiates the value transfer by checking a balance of the user's record (e.g., account) at the sending entity computer 104 at step S8. The first processing computer 108 can provide the sender user account identifier to the sending entity computer 104. The sending entity computer 104 can then look up a balance (e.g., a second value) associated with a sender record associated with the sender user account identifier. The sending entity computer 104 can then transmit a second value (e.g., a balance) associated with the sender record to the first processing computer 108. The first processing computer 108 can then determine if the second value is greater than the value of the transfer (e.g., a first value) to determine if the balance of the sender record is sufficient to transfer the value. If it is sufficient, at step S9, the first processing computer 108 transmits an API call to a second processing computer 110 to initiate the value transfer (see step 222 of FIG. 2D). The API call may comprise details of the value transfer such as the rules of the mandate and user details.

At step S10, after receiving the API call from the first processing computer 108, the second processing computer 110 can conduct risk scoring (see step 224 of FIG. 2D) using the details of the value transfer and user details in API call. The second processing computer 110 can determine a real time authorization decision (see step 226 of FIG. 2D). For example, the second processing computer 110 uses a risk scoring algorithm to determine that the payment transaction should be authorized. The second processing computer provides the authorization decision to the first processing computer 108.

At step S11, the first processing computer 108 provides information regarding the transaction processing to the user device 102. For example, first processing computer 108 provides transaction processing updates to the user device 102. The first processing computer 108 further provides functionality for voiding and cancelling payments. For example, the first processing computer 108 may present to the user (e.g., via the user device 102) a user interface with the transaction status and an option to cancel the transaction. In another example, the first processing computer 108 may transmit an error message to the user device 102. The first processing computer 108 may further deliver a corrective action according to the error (e.g., reauthentication with the sending entity computer) that may be required in certain cases to authorize the payment. If the transaction is authorized in step S10, the first processing computer 108 notifies the user device 102 that the transaction processing for the transaction has completed (see step 228 of FIG. 2D).

At step S12, the second processing computer 110 submits ACH instructions (or another type of payment instruction) for the payment to the sending entity computer 104. At step S13-S14, the sending entity computer 104 sends the payment to the receiving entity computer 105 via transaction network 112 and the value transfer is settled via the transaction network 112.

Once the first processing computer 108 launches the user interface on the user device 102 (steps S3-S4), the first processing computer 108 and the user device 102 maintain direct communication until the user is notified that the transaction has completed (step S11). The first processing computer 108 may manage user facing messaging resulting from the payment authorization process (e.g., success and error messaging) and the delivery of corrective action (e.g., reauthentication with the bank) that may be required in certain cases to authorize a payment.

In some prior systems, after the user confirms the mandate at 216, the user is no longer in communication with the first processing computer 108, but the communication returns back to the resource provider computer 106. If an error occurs during processing, the resource provider computer 106 needs to address the issue, which is burdensome. In embodiments of the invention, however, in embodiments of the invention, the resource provider computer 106 does not need to address or communicate processing issues, since this can be done by the processing computer.

Referring to steps 230 and 232 of FIG. 2D, the resource provider computer 106 may optionally make an API call to retrieve limited account and identity data, and may optionally call an API to initiate payouts and refunds. For example, the payouts and refunds may be conducted via ACH or RTP (real time payments).

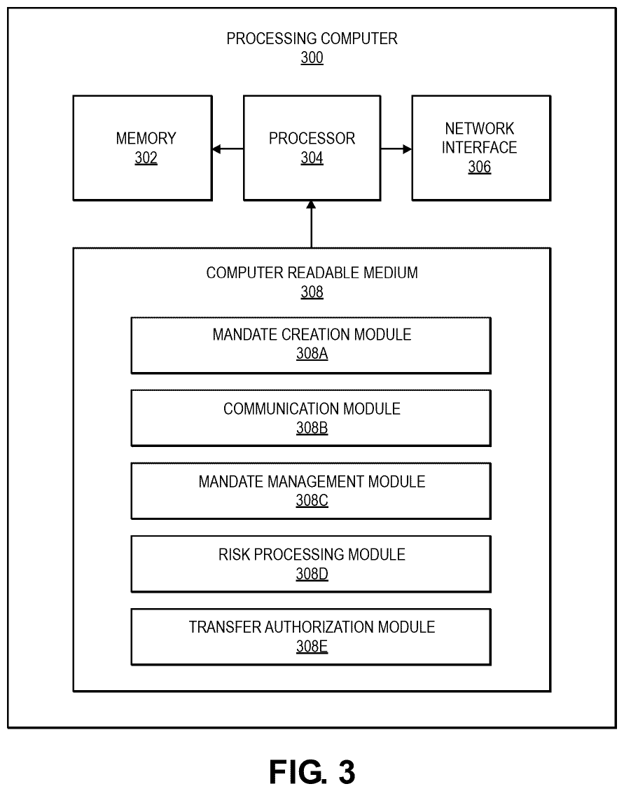

FIG. 3 illustrates a block diagram of a processing computer 300 according to embodiments. The processing computer 300 may include a processor 304 coupled to a memory 302, a network interface 306 and a computer readable medium 308. The computer readable medium 308 can comprise one or more of a mandate creation module 308A, a communication module 308B, a mandate management module 308C, a risk processing module 308D, and a transfer authorization module 308E.

The computer readable medium 308 may comprise code, executable by the processor 304, for performing a method comprising: a) receiving, by a processing computer from a resource provider computer, a request to create a mandate; b) communicating, by the processing computer, with a user device; c) creating, by the processing computer, the mandate; d) providing, by the processing computer to the resource provider computer, a mandate identifier for the mandate; e) receiving, by the processing computer, a call from the resource provider computer with the mandate identifier to initiate a transfer associated with the mandate; f) initiating, by the processing computer, the transfer associated with the mandate by initiating transfer processing; g) providing, by the processing computer, to the user device, information regarding the transfer processing; and h) notifying, by the processing computer, the user device that the transfer processing for the transfer has been authorized, wherein steps b)-g) are performed while the user device is in communication with the processing computer without the resource provider computer as an intermediary between the user device and the processing computer.

The memory 302 can be used to store data and code. The memory 202 may be coupled to the processor 304 internally or externally (e.g., cloud-based data storage), and may comprise any combination of volatile and/or non-volatile memory, such as RAM, DRAM, ROM, flash, or any other suitable memory device. For example, the memory 302 can store credentials, tokens, resource provider identifiers, account information, etc.

The network interface 306 may include an interface that can allow the alias directory 200 to communicate with external computers. The network interface 206 may enable the processing computer 300 to communicate data to and from another device. Some examples of the network interface 306 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 306 may include Wi-Fi™. Data transferred via the network interface 306 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 306 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

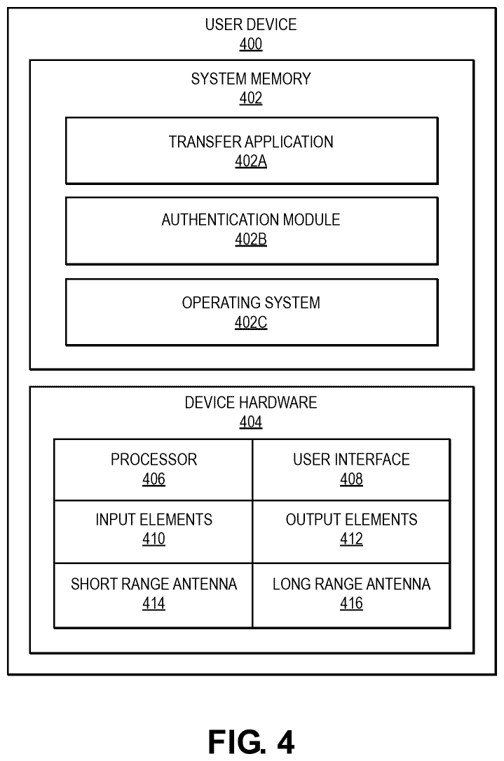

FIG. 4 illustrates a diagram of a user device 400 according to an embodiment. The user device 400 may include device hardware 404 coupled to a system memory 402.

Device hardware 404 may include a processor 406, a short range antenna 414, a long range antenna 416, input elements 410, a user interface 408, and output elements 412 (which may be part of the user interface 408). Examples of input elements may include microphones, keypads, touchscreens, sensors, etc. Examples of output elements may include speakers, display screens, and tactile devices. The processor 406 can be implemented as one or more integrated circuits (e.g., one or more single core or multicore microprocessors and/or microcontrollers), and is used to control the operation of user device 400. The processor 406 can execute a variety of programs in response to program code or computer-readable code stored in the system memory 402, and can maintain multiple concurrently executing programs or processes.

The long range antenna 416 may include one or more RF transceivers and/or connectors that can be used by user device 400 to communicate with other devices and/or to connect with external networks. The long range antenna 416 may be configured to communicate with a remote base station and a remote cellular or data network, over the air. The short range antenna 409 may be configured to communicate with external entities through a short range communication medium. The short range antenna 409 may comprise a contactless interface that can interact with a contactless interface of another device (e.g., a portable device). Examples of a contactless interface may include one or more radio frequency (RF) transceivers that can send and receive communications using near-field communications (NFC), or other radio frequency or wireless communication protocols. The user interface 408 can include any combination of input and output elements to allow a user to interact with and invoke the functionalities of the user device 400.

The system memory 402 can be implemented using any combination of any number of non-volatile memories (e.g., flash memory) and volatile memories (e.g., DRAM, SRAM), or any other non-transitory storage medium, or a combination thereof media. The system memory 402 may store computer code, executable by the processor 406, for performing a method comprising: transmitting, by a user device to a resource provider computer over a communications network, a transfer request message; receiving, by the user device, from the resource provider computer, a redirect from the resource provider computer to a processing computer; providing, by the user device to the processing computer, a selection of a record identifier for a record at a sending entity computer, wherein the processing computer is programmed to create a mandate, provide to the resource provider computer a mandate identifier for the mandate, receive a call from the resource provider computer with the mandate identifier to initiate a transfer associated with the mandate, and initiate the transfer associated with the mandate by initiating transfer processing; and receiving, by the user device from the processing computer, a notification message that the transfer processing for the transfer has been authorized.

The system memory 402 may also store a transfer application 402A, an authentication module 402B, and an operating system 402C. The transfer application 402A may include instructions or code executable by the processor 406 for communicating with a another entity computer. For example, the transfer application 402A may comprise logic, executable by the processor 406 for transmitting a request message (e.g., to a resource provider computer) and receiving a response during an interaction. The authentication module 402B may comprise code, executable by the processor 406, to authenticate a user. This can be performed using user secrets (e.g., passwords) or user biometrics.

Embodiments of the disclosure provide a number of advantages. Embodiments of the disclosure introduce a hosted payment user interface to facilitate authorization, success and error messaging, account linking, and payment confirmation. Traditional methods require resource providers to provide their own user experience within their mobile apps or sites to their users in order to initiate a payment. With embodiments of the invention, resource providers can initiate payments and provide users an end-to-end payment experience with a single API call, and the resource providers do not need to undertake difficult implementation and costly maintenance. Embodiments can provide payment status updates and void payment functionality, enabling users to understand payment statuses and manage payments. As a result, payment authorization rates can increase.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
a) receiving, by a processing computer from a resource provider computer, a request to create a mandate;
b) communicating, by the processing computer, with a user device;
c) creating, by the processing computer, the mandate;
d) providing, by the processing computer to the resource provider computer, a mandate identifier for the mandate;
e) receiving, by the processing computer, a call from the resource provider computer with the mandate identifier to initiate a transfer associated with the mandate;
f) initiating, by the processing computer, the transfer associated with the mandate by initiating transfer processing;
g) providing, by the processing computer, to the user device, information regarding the transfer processing; and
h) notifying, by the processing computer, the user device that the transfer processing for the transfer has been authorized,
wherein steps b)-g) are performed while the user device is in communication with the processing computer without the resource provider computer as an intermediary between the user device and the processing computer.

2. The method of claim 1, wherein the call is an API call.

3. The method of claim 1, wherein notifying, by the processing computer, the user device that the transfer processing for the transfer has been authorized comprises notifying, by the processing computer via the resource provider computer, the user device that the transfer processing for the transfer has been authorized.

4. The method of claim 1, wherein the transfer processing comprises:
communicating, with a sending entity computer, to determine a second value of a record associated with a user; and
determining, by the processing computer if a first value associated with the transfer is less than the second value.

5. The method of claim 4, wherein the processing computer is a first processing computer, and wherein the transfer processing further comprises:
transmitting an API call to a second processing computer, wherein the second processing computer is programmed to perform a risk analysis on the transfer and provide an authorization decision to the first processing computer.

6. The method of claim 5, wherein the second processing computer is further programmed to transmit a message, via a communication network, to the sending entity computer to transfer the first value to a receiving entity computer.

7. The method of claim 5, the second processing computer is further programmed to transmit a message, via a communication network, to the sending entity computer to transfer the first value to a receiving entity computer via a transaction network.

8. The method of claim 1, wherein the transfer processing comprises:
communicating, with a sending entity computer, to determine a second value of a record associated with a user; and
determining, by the processing computer if a first value associated with the transfer is less than the second value, and wherein the method further comprises, after step b):
receiving, by the processing computer, a selection of an identifier associated with the record at the sending entity computer.

9. The method of claim 1, wherein, after step a), the resource provider computer provides, to the user device, a re-direct to the processing computer.

10. The method of claim 9, wherein the re-direct is an iFrame or a URL to the processing computer.

11. The method of claim 1, wherein the user device is operated by a user and is a sender, and the transfer is for the transfer of a value from a sender record of the sender to a receiver record of a receiver, and wherein the mandate comprises a sender record identifier, a receiver record identifier, and the value.

12. The method of claim 1, wherein notifying, by the processing computer, the user device that the transfer processing for the transfer has been authorized comprises notifying, by the processing computer the user device that the transfer processing for the transfer has been authorized without the resource provider computer as the intermediary between the user device and the processing computer.

13. A processing computer comprising:
a processor; and
a non-transitory computer readable medium, the non-transitory computer readable medium comprising code, executable by the processor, for performing a method comprising:
a) receiving, from a resource provider computer, a request to create a mandate;
b) communicating with a user device;
c) creating the mandate;
d) providing, to the resource provider computer, a mandate identifier for the mandate;
e) receiving a call from the resource provider computer with the mandate identifier to initiate a transfer associated with the mandate;
f) initiating the transfer associated with the mandate by initiating transfer processing;
g) providing to the user device, information regarding the transfer processing; and
h) notifying the user device that the transfer processing for the transfer has been authorized,
wherein steps b)-g) are performed while the user device is in communication with the processing computer without the resource provider computer as an intermediary between the user device and the processing computer.

14. The processing computer of claim 13, wherein the user device is operated by a user and is a sender, and wherein the transfer processing comprises:
communicating, with a sending entity computer, to determine a second value of a sender record associated with the sender; and
determining, by the processing computer if a first value associated with the transfer is less than the first value, and wherein the method further comprises, after step b):
receiving, by the processing computer, a selection of a sender record identifier associated with the sender record at the sending entity computer.

15. The processing computer of claim 13, wherein notifying, by the processing computer, the user device that the transfer processing for the transfer has authorized comprises notifying, by the processing computer the user device that the transfer processing for the transfer has authorized without the resource provider computer as the intermediary between the user device and the processing computer.

16. A method comprising:
transmitting, by a user device to a resource provider computer over a communications network, a transfer request message;
receiving, by the user device, from the resource provider computer, a redirect from the resource provider computer to a processing computer;
providing, by the user device to the processing computer, a selection of a record identifier for a record at a sending entity computer, wherein the processing computer is programmed to create a mandate, provide to the resource provider computer a mandate identifier for the mandate, receive a call from the resource provider computer with the mandate identifier to initiate a transfer associated with the mandate, and initiate the transfer associated with the mandate by initiating transfer processing; and
receiving, by the user device from the processing computer, a notification message that the transfer processing for the transfer has been authorized.

17. The method of claim 15, wherein the user device is a mobile phone.

18. The method of claim 15, wherein the redirect is a URL or an iFrame.

19. The method of claim 15, wherein the mandate identifier is a random number.

20. The method of claim 15, wherein receiving, by the user device from the processing computer, a notification message that the transfer processing for the transfer has been authorized occurs without the resource provider computer being an intermediary.
